(19) United States
(12) Patent Application Publication
(10) Pub. No.: US 2020/0215886 A1
(43) Pub. Date: Jul. 9, 2020

(54) OPEN-AIR CAR CANOPY SCOOP RETENTION DEVICE

(71) Applicant: Michael P. Held, West Seneca, NY (US)

(72) Inventor: Michael P. Held, West Seneca, NY (US)

(21) Appl. No.: 16/737,457

(22) Filed: Jan. 8, 2020

Related U.S. Application Data
(60) Provisional application No. 62/789,555, filed on Jan. 8, 2019.

(51) Int. Cl. B60J 7/10; F16B 2/22

(52) U.S. Cl. CPC B60J 7/102; F16B 2/22

(57) ABSTRACT

An open-air car canopy scoop retention device attaches to the rear structure of an open-air car for stowage of a rear canopy in a compacted position. The device provides an elongated, concave panel and a concave bracket that detachably join at their edges to form a C-shaped canopy channel. The channel retains the canopy located at rear of open-air car. A panel free side has a curved lip that allows the canopy to easily ingress and egress the C-shaped channel. Drainage holes in panel allow moisture to escape from C-shaped channel. A mount clip detachably attaches to mount bracket. The mount clip has a first clip side fastenable to the bracket, and a second clip side with a prong that mates with rear cross bar of open-air car. A mount bar and mount clip fasten on opposing sides of the rear crossbar to fasten device to rear of open-air car.

### CROSS REFERENCE OF RELATED APPLICATIONS

This application claims the benefits of U.S. provisional application No. 62/789,555, filed Jan. 8, 2019 and entitled OPEN-AIR CAR CANOPY RETENTION APPARATUS, which provisional application is incorporated by reference herein in its entirety.

### FIELD OF THE INVENTION

The present invention relates generally to an open-air car canopy scoop retention device. More so, the canopy scoop retention device provides a concave panel forming a bow-shaped channel, and having multiple drainage openings; whereby the panel has a free side and a mount side that attaches to the rear roof structure of an open-air car for stowing a rearwardly extending canopy.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, an open-air car is utilized to transport occupants between locations in an efficient manner. One such open-air car is a golf cart, which is employed primarily by golfers. Although golf carts are also used by policemen in the performance of their duties, invalid persons unable to walk any great distance, and companies on large campuses. Often, golf carts are constructed as to enable two persons to occupy each cart and a seating area is provided for the occupants of the cart. In many instances, a storage area is rearwardly disposed to the seat area which receives and retains equipment such as a bag and golf clubs of a golfer.

Typically, golf carts install a rear compartment canopy to protect the rear compartment and its contents. The canopy can be easily opened as needed to access the contents carried in the rear compartment and closed when the cart is not in use. It is known in the art to have canopies for golf cart rear compartments. Generally, it advantageous for the canopy to unfold over and in close proximity to the clubs to minimize exposure to the weather. The canopy is often a portable, removable rear cover having a resilient cover that drapes over hingedly rotatable, or sliding supporting brackets.

Other proposals have involved canopies for open-air cars. The problem with these canopies is that they do not easily stow into the golf cart after use. Also, they do not interchangeably attach between different golf carts. Even though the above cited golf cart canopies meet some of the needs of the market, an open-air car canopy scoop retention device that provides a concave panel forming a bow-shaped channel, and multiple drainage openings; whereby the panel has a free side and a mount side that attaches to the rear roof structure of an open-air car for stowing a rearwardly extending canopy, is still desired.

### SUMMARY

Illustrative embodiments of the disclosure are generally directed to an open-air car canopy scoop retention device. The canopy retention device attaches to the rear roof structure of an open-air car, so as to enable organized and easy stowage of a rear canopy; retaining the rear canopy of the open-air car in a compacted, out-of-the-way position. The canopy can be from an open-air car, such as those used in golf carts to shield an uncovered rear deck.

In one embodiment of the present invention the canopy retention device provides an elongated, concave panel and a concave bracket that detachably join at their edges to form a C-shaped channel, adapted to securely retain the compacted (folded) canopy. A panel free side has a curved lip that is configured to enable easy egress/ingress of the canopy from the C-shaped channel. Drainage holes in the panel allow moisture to escape from the C-shaped channel, and the canopy contained therein.

In another embodiment, a mount clip detachably attaches to the bracket. The mount clip has a first clip side that fastens to the bracket, and a second clip side with a prong that mates with a rear cross bar at the rear section of the open-air car. A mount bar and mount clip fasten on opposing sides of the rear crossbar to fasten device to rear of open-air car, encapsulating the rear cross bar from opposing sides. This can create a secure, yet easily detachable fastening point for canopy retention device to rear roof structure of open-air car.

The open-air car canopy scoop retention device, comprises:
an elongated, concave panel defined by an outer surface and an inner surface, the panel further being defined by a panel mount side and a panel free side, the panel mount side having a mount flange, the panel free side having a curved lip;
an elongated, concave mount bracket being detachably attachable to the mount flange of the panel, the mount bracket defined by a bracket mount side and a bracket free side, the bracket mount side adapted to mate with the panel mount side,
whereby the panel and the bracket join to form a C-shape canopy cavity adapted to enable retention of a canopy;
an elongated mount bar, the mount bar being detachably attachable to the bracket free side; and
a mount clip detachably attachable to the bracket free side, the mount clip defined by a first clip side and a second clip side.

In another aspect, the panel is defined by multiple drainage openings.

In another aspect, the drainage openings are diamond-shaped.

In another aspect, the mount flange of the panel mount side is defined by multiple panel mounting holes.

In another aspect, the bracket mount side and the bracket free side are defined by multiple bracket mounting holes.

In another aspect, the device also provides at least one fastener, such as a screw and nut.

In another aspect, the fastener is sized and dimensioned to pass through the panel mounting holes and the bracket mounting holes.

In another aspect, the first clip side of the mount clip joins with the bracket free side.

In another aspect, the mount clip flexes about the mount bracket.

In another aspect, the first clip side of the mount clip forms multiple clip mounting holes.

In another aspect, the fastener is configured to pass through the clip mounting holes and the bracket mounting holes of the bracket free side.

In another aspect, the second clip side of the mount clip is defined by a U-shape.

In another aspect, the second clip side of the mount clip comprises a prong.

In another aspect, the prong of the second clip side is operable to enable detachable attachment to a rear roof structure of an open-air car.

In another aspect, the canopy is deployable from the open-air car.

In another aspect, the panel is fabricated from a semi-rigid polymer.

In another aspect, the panel comprises fabricated from a resilient polymer.

One objective of the present invention is to provide a concave panel that securely retains a canopy for a golf-cart in a compacted position, and enabling easy access to deploy the canopy across the rear of the open-air car.

Yet another objective is to retain a rear canopy of an open-air car out of the line of sight of the occupants.

Another objective is to securely retain the rear canopy in a fixed position at the undeployed positions through use of a concave panel.

Yet another objective is to allow easy access to the clubs in the rear section of a golf cart by rolling up the rear canopy into the retention device.

In another possible objective, the panel is configured to drain water that accumulates in the concave panel through drain holes.

Yet another objective is to block the wind from knocking out the rear canopy through use of a substantially solid piece panel that retains the rear canopy.

Another objective is to provide at least one fastener, such as screws, nails, nuts, bolts, magnets, and adhesives for easy fastening of the retention device to the rear roof mounting surface of the open-air car.

Yet another objective is to provide an inexpensive to manufacture open-air car canopy retention device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a front view of an exemplary open-air car canopy scoop retention device, showing a panel, a mount bracket, and a mount bar fastened together, in accordance with an embodiment of the present invention;

FIG. 2 illustrates a front perspective view of the open-air car canopy scoop retention device, in accordance with an embodiment of the present invention;

FIG. 3 illustrates a rear perspective view of the open-air car canopy scoop retention device, in accordance with an embodiment of the present invention;

FIG. 4 illustrates an elevated side view of the open-air car canopy scoop retention device, in accordance with an embodiment of the present invention;

FIG. 5 illustrates an upper perspective view of the concave panel, in accordance with an embodiment of the present invention;

FIG. 6 illustrates an upper perspective view of the concave panel joined with the mount bracket to form a C-shaped channel, in accordance with an embodiment of the present invention;

FIG. 7 illustrates an upper perspective view of the concave panel joined with the mount bracket, and a mount clip joined to the mount bracket, in accordance with an embodiment of the present invention;

FIG. 8 illustrates a rear perspective view of a rear for an exemplary open-air car, showing the canopy fully deployed from the rear roof structure, in accordance with an embodiment of the present invention;

FIG. 9 illustrates a side view of the rear roof structure with a canopy, in accordance with an embodiment of the present invention;

FIG. 10 illustrates a lower perspective view of the C-shaped channel retaining the canopy at the rear roof structure, in accordance with an embodiment of the present invention;

FIG. 11 illustrates a perspective view of the canopy being compacted to the rolled-up configuration, and into the C-shaped channel, in accordance with an embodiment of the present invention; and

FIG. 12 illustrates a perspective view of the canopy fully retained in the C-shaped channel, in accordance with an embodiment of the present invention.

Like reference numerals refer to like parts throughout the various views of the drawings.

### DETAILED DESCRIPTION OF THE INVENTION

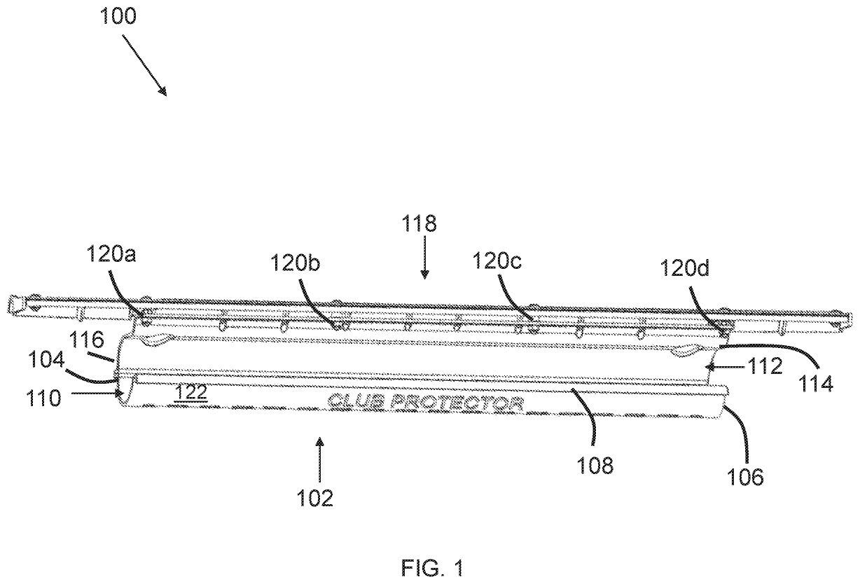

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific systems and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-12, an open-air car canopy scoop retention device 100 provides a unique C-shaped channel 110 that affixes to a rear roof structure of an open-air car 800 to enable easy compacting and retention of a canopy 804 that is operable and deployable directly from the rear roof structure 802 of open-air car 800. Open-air car canopy scoop retention device 100, hereafter “device 100”, utilizes both curved and fastenable, edges that allow the canopy 804 to easily slide in and out of the C-shaped channel 110, while detachably affixing to the rear roof structure 802 of the open-air car 800 through at least one fastener 120a-f. Multiple drainage openings 202a-n are sized to enable moisture to drain from the C-shaped channel 110 so that the canopy 804 does not spoil, i.e., retain mildew, deteriorate, etc., due to contact with the moisture.

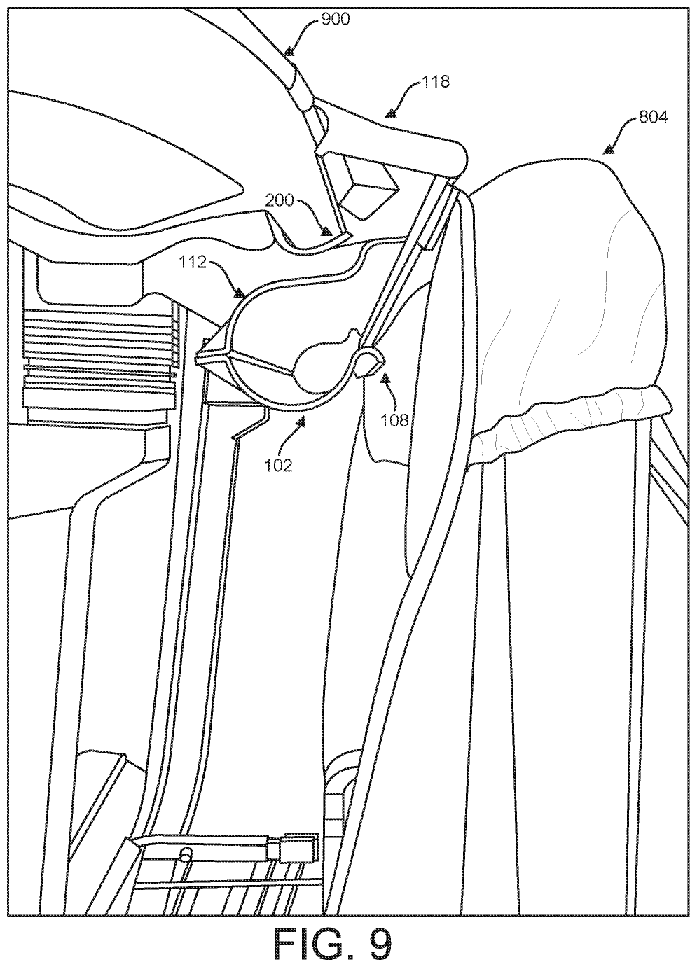

Those skilled in the art will recognize that an open-air car 800, such as a golf cart, often has a rear compartment canopy to protect the rear compartment and contents therein. The canopy 804 can be easily opened as needed to access the contents carried in the rear compartment and closed when the open-air car 800 is not in use. It is known in the art to have canopies for a golf cart rear compartment. The canopy 804 is often a portable, removable rear cover having a resilient cover that drapes over hingedly rotatable, or sliding supporting brackets. Often, it is advantageous for the canopy 804 to deploy over, and in close proximity to the golf clubs, so as to minimize exposure to the weather (See FIG. 9).

It is also recognized that the rear canopy can be moved between a deployed position and an undeployed position. Currently available canopies are releasably secured in the non-operative, undeployed, condition by means of a hook and loop-type fastener including a loop bundle strip attached at one end to the back section of the cover section and a hook bundle strip fixedly secured atop an attachment member. In alternative embodiments, snaps are also used to secure the canopies when undeployed. The present invention is designed to not only easily attach to the open-air car 800, but also to securely retain the rear canopy thereon.

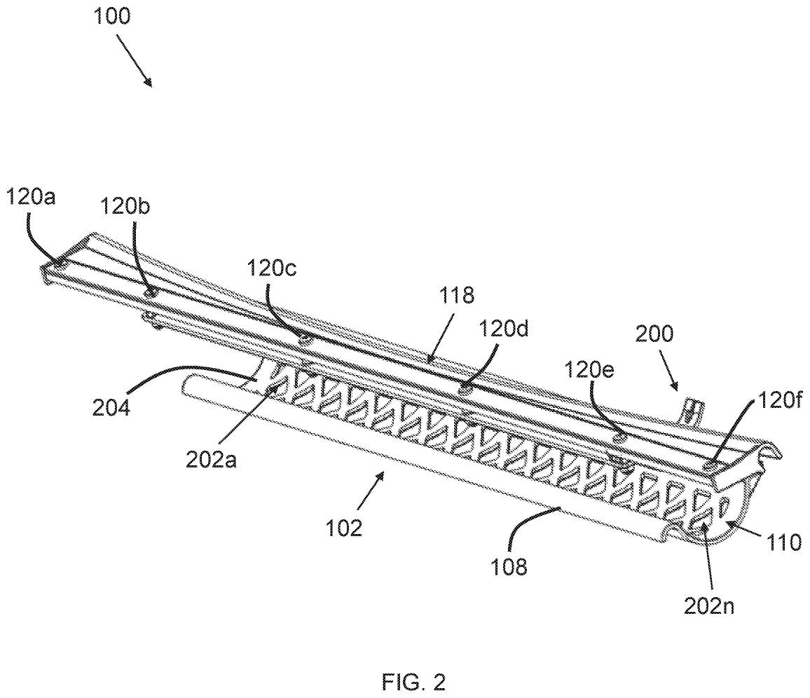

Looking at FIG. 2, device 100 provides an elongated, concave panel 102. Panel 102 has a unique concave/curved configuration that forms a secure channel for retaining canopy 804. Additionally, panel 102 includes fastenable ends that allow for easy attachment to the rear roof structure 802 of an open-air car 800. Panel 102 follows a semi-cylindrical, or trough shape, that forms a cavity for retaining the rear canopy 804 when rolled into a compact form. Panel 102 is sufficiently resilient, so that it can be bent downwardly to load or unload the rear canopy from within the cavity.

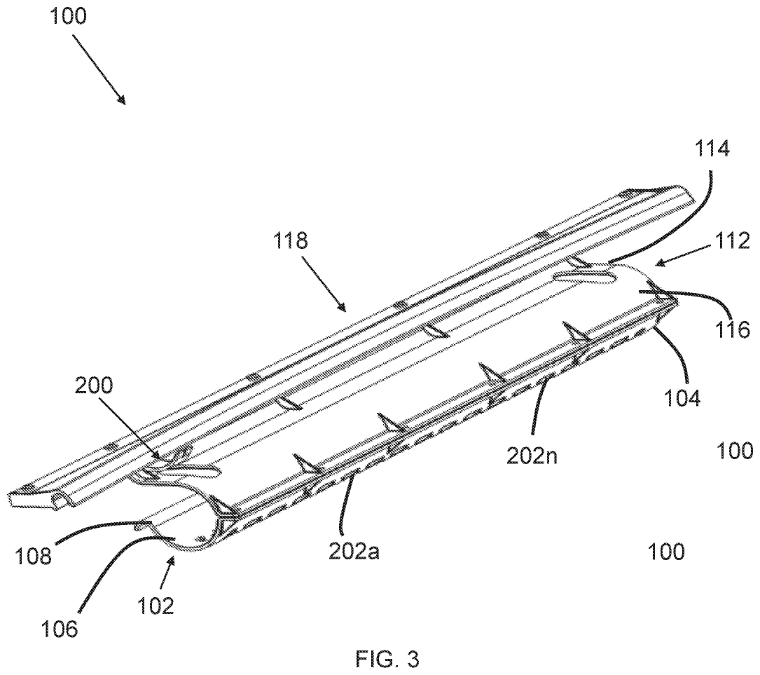

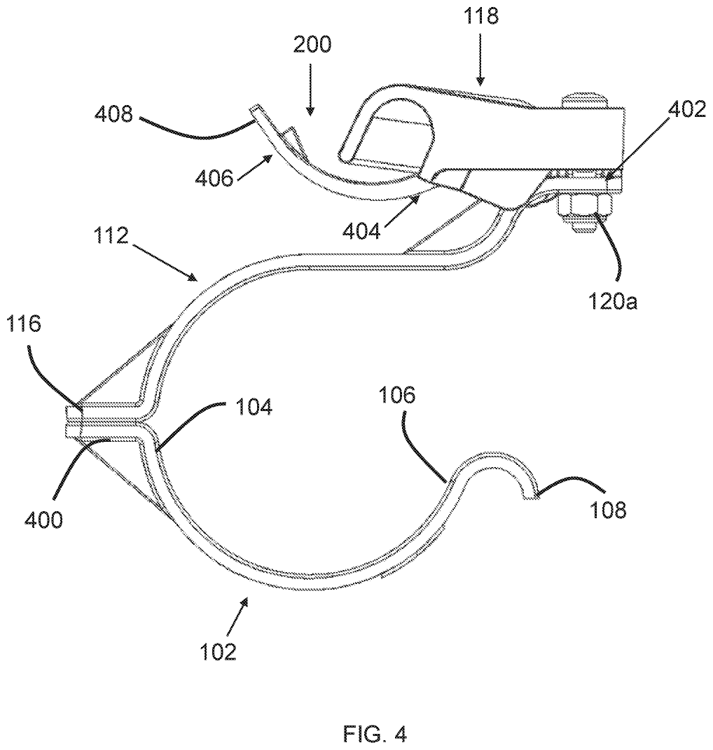

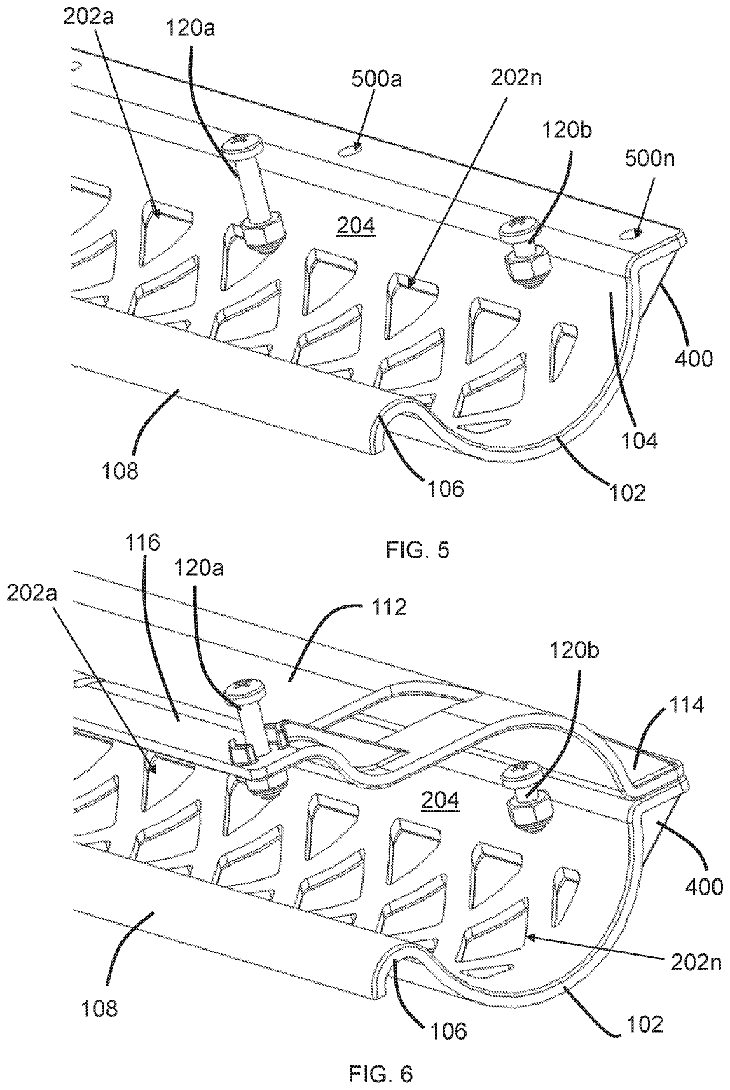

As FIG. 3 shows, panel 102 is defined by an outer surface 122 and an inner surface 204. Panel 102 also includes a panel mount side 104 and a panel free side 106. Panel mount side 104 has a mount flange 400. In some embodiments, mount flange 400 of the panel mount side 104 is defined by multiple panel mounting holes 500a, 500n (See FIG. 5). This may include spaced-apart panel mounting holes 500a-n that are sized and dimensioned to enable passage of at least one fastener 120a-f, discussed below. And, as FIG. 4 illustrates, panel 102 also has a panel free side 106, opposite panel mount side 104. Panel free side 106 is configured with a curved lip 108. Curved lip 108 is designed to enable canopy 804 to easily ingress/egress, i.e., slide in and out, of C-shaped channel 110. In another non-limiting embodiment, the smooth shape of curved lip 108 helps prevent accidental snagging of canopy 804.

In some embodiments, panel 102 is defined by multiple drainage openings 202a-n. Drainage openings 202a-n form in panel 102 to allow rain/moisture to escape from C-shaped channel 110; thereby minimizing exposure to moisture for the canopy 804 contained therein. In one non-limiting embodiment, the drainage openings 202a-n are diamond-shaped. Though in other embodiments, other shapes, including sloped edges at the drainage openings 202a-n can be used. In some embodiments, panel 102 is fabricated from a semi-rigid polymer. In other embodiments, panel 102 comprises fabricated from a resilient polymer.

Turning now to FIG. 5, device 100 provides an elongated, concave mount bracket 112 that is detachably attachable to the mount flange of the panel 102. Mount bracket 112 is defined by a bracket mount side 114 and a bracket free side 116. Bracket mount side 114 is adapted to mate with the panel mount side 104. In some embodiments, panel 102 is fabricated from a semi-rigid polymer. In other embodiments, panel 102 comprises fabricated from a resilient polymer.

In some embodiments, bracket mount side 114 and bracket free side 116 are defined by multiple bracket mounting holes 402 that allow for fastening to panel 102. In this manner, panel 102 and mount bracket 112 are joined to form a C-shape channel 110 that is adapted to enable retention of canopy 804 (See FIG. 6). It is this unique C-shape of channel 110 that has sufficient volume to retain a canopy 804, as those known in the art to reside on golf carts. Further, the curved lip 108 that terminates the panel free side 106 allows for the canopy to easily slide in and out of C-shaped channel 110.

In one embodiment, the rear roof structure 802 of open-air car 800 is a cross-bar that traverse the rear of the open-air car 800. The rear roof structure 802 supports the canopy when in the deployed position. Thus, when the rear canopy of open-air car 800 is released to fall to the deployed position, the canopy shields the uncovered rear deck of open-air car 800. Conversely, when canopy is disposed in an undeployed position, the canopy 804 drapes down to cover the rear sight line. Further, the folds in the canopy 804 have a tendency to collect dirt, moisture, and other undesirable debris.

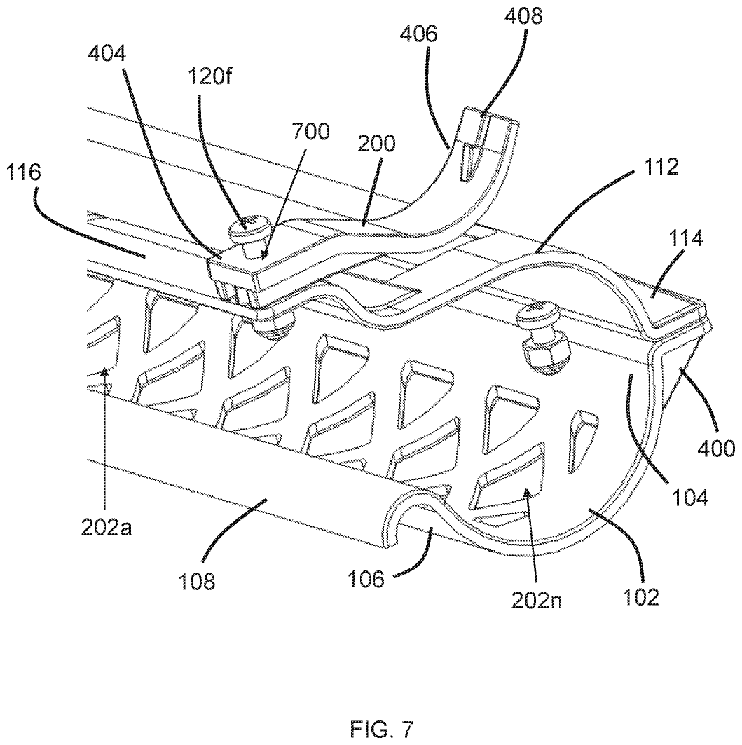

Looking now at FIG. 7, device 100 also utilizes a unique mount clip 200 that is detachably attachable to the bracket free side 116. Mount clip 200 serves to enable easy attachment/detachment to rear roof structure 802. Mount clip 200 has a first clip side 404 and a second clip side 406. Second clip side 406 of mount clip 200 is defined by a U-shape, terminating at a prong 408. In another embodiment, the prong 408 of second clip side 406 is operable to enable detachable attachment to a rear roof structure 802 of an open-air car 800. In one non-limiting embodiment, prong 408 is a wedge with a pointed end that grips a rear crossbar 900 of the rear roof structure 802.

In one possible embodiment, prong 408 and curved configuration of second clip side 406 enable easy attachment to rear roof structure 802. Though in other embodiments, bracket free side 116 of mount bracket 112 attaches to the rear roof structure 802 through magnetic, welding, or adhesive means. In another embodiment, mount clip 200 flexes about the mount bracket 112. This provides free play for supporting the weight of the canopy 804.

Looking back at FIG. 5, device 100 also provides at least one fastener 120a-f, such as a screw and nut. Though fastener 120a-f may also include, without limitation, a bolt, a nail, a magnet, and a friction-fit fastening mechanism. Fastener 120a-f is sized and dimensioned to pass through panel mounting holes 500a-n and bracket mounting holes 402. This allows the panel 102, mount bracket 112, and mount clip 200 to easily and quickly attach/detach from their respective connection points. Fastener 120a-f is configured to fasten the mount bracket 112 to rear roof structure 802. In one example of fastener connecting components through mounting holes, the panel and bracket mounting holes 500a-n, 402, and fastener 120a-f may be threaded, forming a screw-nut fastening mechanism.

In one possible embodiment, first clip side 404 of mount clip 200 joins with the bracket free side 116, creating an easy fastenability to the rear roof structure 802, adjacent to an undeployed canopy. In another embodiment, first clip side 404 forms multiple clip mounting holes 700. Thus, as FIG. 7 shows, the fastener 120f is configured to pass through the clip mounting holes 700 and the bracket mounting holes of the bracket free side 116. In other embodiments, an elongated mount bar 118 detachably attaches to the bracket free side 116.

Mount bar 118 may be fastened between mount clip 200 and mount bracket 112. In this manner, the rear roof structure 802 is retained between the flexible mount clip 200 and the mount bar 118 for secure retention therebetween. In one embodiment, resilient configurations of mount clip 200 and the mount bar 118 fasten on both sides of a rear crossbar 900 for rear roof structure 802, encapsulating crossbar 900 from opposing sides. However, in other embodiments, mount clip 200 can attach to rear roof structure 802 independently of mount bar 118.

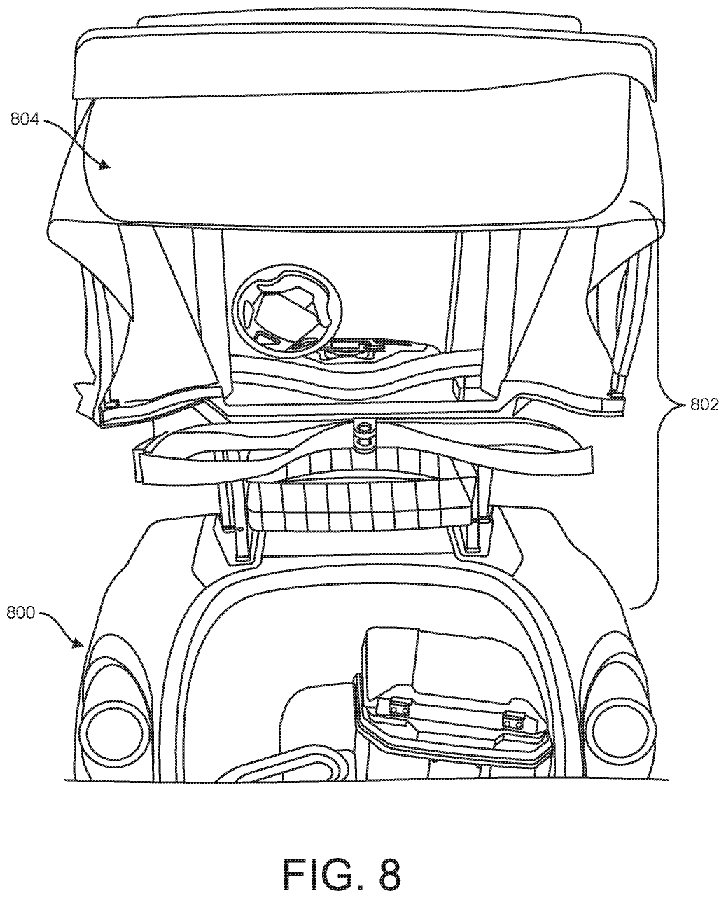

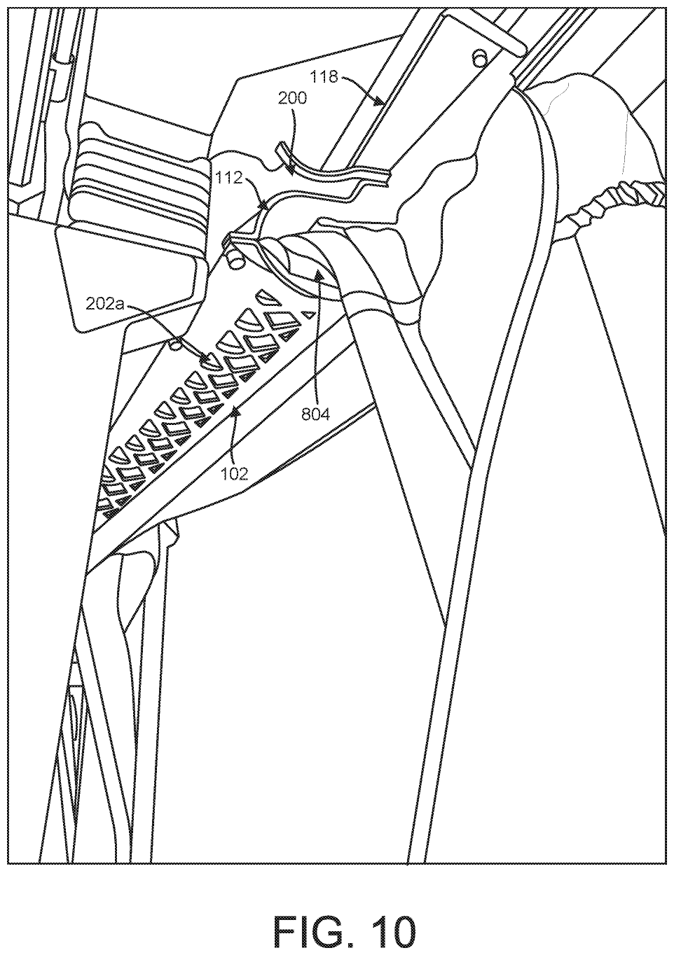

In operation, shown in FIG. 8, canopy 804 is fully deployed and unfolded over and in close proximity to clubs in the rear section of open-air car 800. The deployed shape of canopy 804 serves to minimize exposure to the weather. As shown, canopy 804 is often a portable, removable rear cover having a resilient cover that drapes over hingedly rotatable, or sliding supporting brackets. As FIG. 9 shows, device 100 attaches to rear roof structure 802 from bracket, so as to provide a C-shaped channel 110 for retaining adjacent canopy 804. Continuing, a user can easily compact, i.e., roll up the canopy 804 to achieve a folded, undeployed position directly from the rear roof structure 802 of open-air car 800 (See FIG. 10).

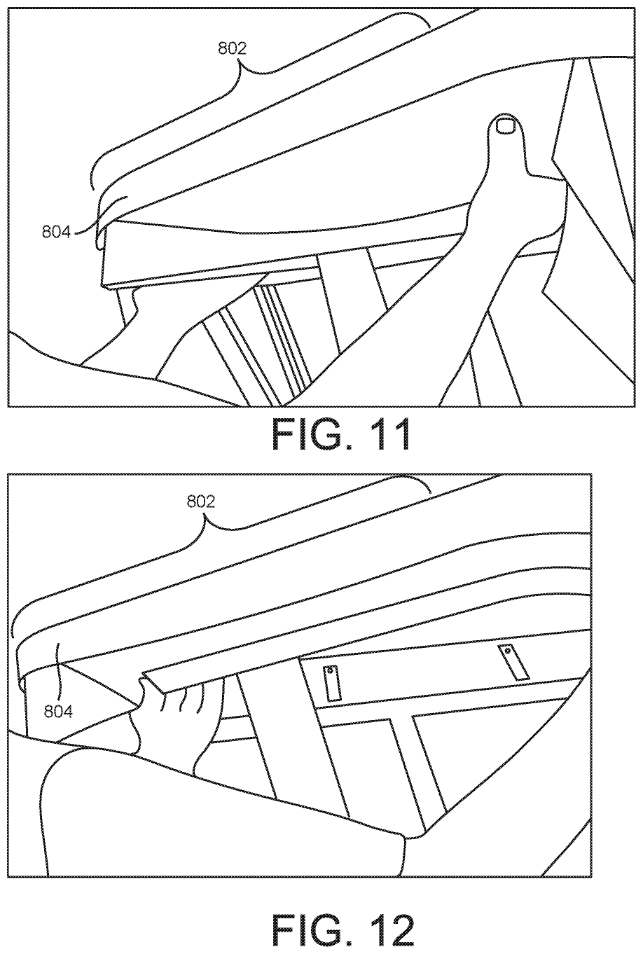

Once canopy 804 is compacted to the rolled-up configuration, canopy can be slid over the curved lip 108 of panel 102, into the C-shaped channel 110 (See FIG. 11). Rolled up canopy can be pulled lengthwise to better fit into channel. Canopy 804 is then securely retained during operation of open-air car 800. As FIG. 12 illustrates, when canopy 804 is fully compacted into C-shaped channel 110, it is out of sight, and protected from the external environment. In conclusion, device 100 provides a concave panel 102 that securely retains a canopy for a golf-cart in a compacted position, and enabling easy access to deploy the canopy 804 across the rear of the open-air car 800.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. An open-air car canopy scoop retention device, the device comprising:
an elongated, concave panel defined by an outer surface and an inner surface, the panel further being defined by a panel mount side and a panel free side, the panel mount side having a mount flange, the panel free side having a curved lip;
an elongated, concave mount bracket being detachably attachable to the mount flange of the panel, the mount bracket defined by a bracket mount side and a bracket free side, the bracket mount side adapted to mate with the panel mount side,
whereby the panel and the bracket join to form a C-shape canopy cavity adapted to enable retention of a canopy; and
a mount clip detachably attachable to the bracket free side, the mount clip defined by a first clip side and a second clip side.

2. The device of claim 1, wherein the panel is defined by multiple drainage openings.

3. The device of claim 2, wherein the drainage openings are diamond-shaped.

4. The device of claim 1, wherein the mount flange of the panel mount side is defined by multiple panel mounting holes.

5. The device of claim 4, wherein the bracket mount side and the bracket free side are defined by multiple bracket mounting holes.

6. The device of claim 5, further comprising at least one fastener.

7. The device of claim 6, wherein the fastener comprises a screw and nut.

8. The device of claim 7, wherein the fastener is sized and dimensioned to pass through the panel mounting holes and the bracket mounting holes.

9. The device of claim 1, wherein the first clip side of the mount clip joins with the bracket free side.

10. The device of claim 1, wherein the mount clip flexes about the mount bracket.

11. The device of claim 6, wherein the first clip side of the mount clip forms multiple clip mounting holes.

12. The device of claim 11, wherein the at least one fastener is configured to pass through the clip mounting holes and the bracket mounting holes of the bracket free side.

13. The device of claim 12, wherein the second clip side of the mount clip is defined by a U-shape.

14. The device of claim 13, wherein the second clip side of the mount clip comprises a prong.

15. The device of claim 14, wherein the prong is operable to enable detachable attachment to a rear roof structure of an open-air car.

16. The device of claim 1, wherein the panel is fabricated from a semi-rigid polymer.

17. The device of claim 1, further comprising an elongated mount bar, the mount bar being detachably attachable to the bracket free side.

18. An open-air car canopy scoop retention device, the device comprising:
an elongated, concave panel defined by an outer surface and an inner surface, the panel further being defined by a panel mount side and a panel free side, the panel mount side having a mount flange, the panel free side having a curved lip, the panel being defined by multiple drainage openings;
an elongated, concave mount bracket being detachably attachable to the mount flange of the panel, the mount bracket defined by a bracket mount side and a bracket free side, the bracket mount side adapted to mate with the panel mount side,
whereby the panel and the bracket join to form a C-shape canopy cavity adapted to enable retention of a canopy;
a mount clip detachably attachable to the bracket free side, the mount clip defined by a first clip side and a second clip side, the first clip side of the mount clip detachably attachable to the bracket free side, the second clip side of the mount clip comprising a prong; and
at least one fastener, the fastener operable to fasten the panel to the mount bracket, the fastener further being operable to fasten the mount clip to the mount bracket.

19. The device of claim 18, further comprising an elongated mount bar, the mount bar being detachably attachable to the bracket free side.

20. An open-air car canopy scoop retention device, the device consisting of:
an elongated, concave panel defined by an outer surface and an inner surface, the panel further being defined by a panel mount side and a panel free side, the panel mount side having a mount flange, the panel free side having a curved lip, the panel being defined by multiple drainage openings;
an elongated, concave mount bracket being detachably attachable to the mount flange of the panel, the mount bracket defined by a bracket mount side and a bracket free side, the bracket mount side and the bracket free side being defined by multiple bracket mounting holes, the bracket mount side adapted to mate with the panel mount side,
whereby the panel and the bracket join to form a C-shape canopy cavity adapted to enable retention of a canopy;
a mount clip detachably attachable to the bracket free side, the mount clip defined by a first clip side and a second clip side, the first clip side of the mount clip detachably attachable to the bracket free side, the first clip side of the mount clip forming multiple clip mounting holes, the second clip side of the mount clip comprising a prong, the prong of the second clip side being operable to enable detachable attachment to a rear roof structure of an open-air car;
an elongated mount bar, the mount bar being detachably attachable to the bracket free side; and
at least one fastener, the fastener operable to fasten the panel to the mount bracket through the panel mounting holes and the bracket mounting holes, the fastener further being operable to fasten the mount clip to the mount bracket through the bracket mounting holes and the clip mounting holes.
